(19) United States
(12) Patent Application Publication
(10) Pub. No.: US 2026/0303482 A1
(43) Pub. Date: Oct. 1, 2026

(54) ARTIFICIAL INTELLIGENCE DRIVEN AUTOMATED NETWORK TO MEET CLIMATE SUSTAINABILITY AND SPECTRUM EFFICIENCY GOALS

(71) Applicants: AT&T Intellectual Property I, L.P., Atlanta, GA (US); AT&T Mobility II LLC, Atlanta, GA (US)

(72) Inventors: Prashant Raghuvanshi, Parker, CO (US); Richard T. Kwapniewski, Middletown, NJ (US)

(73) Assignees: AT&T Intellectual Property I, L.P., Atlanta, GA (US); AT&T Mobility II LLC, Atlanta, GA (US)

(21) Appl. No.: 19/093,516

(22) Filed: Mar. 28, 2025

(51) Int. Cl. H04L 41/5009; H04W 24/02

(52) U.S. Cl. CPC H04L 41/5009; H04W 24/02

(57) ABSTRACT

Aspects of the subject disclosure may include, for example, receiving one or more efficiency use case inputs specifying an efficiency target for a mobile communications network, monitoring one or more key performance indicators (KPIs) including energy consumption, spectrum usage, and transport bandwidth utilization, wherein the one or more KPIs are associated with one or more existing network slices of the mobile communications network, automatically determining whether an existing network slice of the one or more existing network slices satisfies the efficiency target, generating configuration data for a new network slice in response to a determination that the existing network slice does not satisfy the efficiency target, and in a slice orchestrator, creating and provisioning the new network slice responsive to the configuration data for meeting designated climate sustainability and spectrum efficiency goals for the mobile communications network. Other embodiments are disclosed.

### FIELD OF THE DISCLOSURE

The subject disclosure relates to a system and method that allows dynamic artificial intelligence/machine learning (AI/ML) driven network deployment to meet specific climate sustainability and network deployment goals for a communications network.

### BACKGROUND

Climate change is impacting many aspects of life and causing many organizations to commit to carbon neutrality. Further, in the telecommunications environment, radio spectrum is becoming an increasingly sparse resource for organizations to access for transport of large quantities of data.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system for slice orchestration within the mobile communication system of FIG. 2A in accordance with various aspects described herein.

FIG. 2C is a block diagram illustrating example operation of the system for slice orchestration within the mobile communication system of FIG. 2A in accordance with various aspects described herein.

FIG. 2D is a block diagram illustrating an example, non-limiting embodiment of a system for improving energy efficiency within the mobile communication system of FIG. 2A in accordance with various aspects described herein.

FIG. 2E is a block diagram illustrating an example, non-limiting embodiment of a system for improving spectrum efficiency within the mobile communication system of FIG. 2A in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an AI-driven system designed to dynamically deploy and optimize network slices in a communications network to achieve specific climate sustainability, spectrum efficiency and bandwidth efficiency goals. A system and method employ an input generation platform, AI/ML engine, and automated process engine to analyze efficiency targets, monitor key performance indicators, and determine the adequacy of existing network slices. If existing slices do not meet the targets, a network blueprint creator generates configuration data for new slices, which are then instantiated and optimized by a slice orchestrator to ensure compliance with the efficiency objectives. Other embodiments are described in the subject disclosure.

One or more aspects of the subject disclosure include receiving one or more efficiency use case inputs specifying an efficiency target for a mobile communications network, monitoring one or more key performance indicators (KPIs) including energy consumption, spectrum usage, and transport bandwidth utilization, wherein the one or more KPIs are associated with one or more existing network slices of the mobile communications network, automatically determining whether an existing network slice of the one or more existing network slices satisfies the efficiency target, generating configuration data for a new network slice in response to a determination that the existing network slice does not satisfy the efficiency target, and in a slice orchestrator, creating and provisioning the new network slice responsive to the configuration data for meeting designated climate sustainability and spectrum efficiency goals for the mobile communications network.

One or more aspects of the subject disclosure include receiving one or more efficiency use case inputs specifying an efficiency target for a mobile communications network, monitoring one or more key performance indicators (KPIs) including energy consumption, spectrum usage, and transport bandwidth utilization associated with one or more existing network slices of the mobile communications network, automatically determining whether an existing network slice of the one or more existing network slices satisfies the efficiency target, generating configuration data for a new network slice in response to a determination that the existing network slice does not satisfy the efficiency target, in a slice orchestrator, creating and provisioning the new network slice responsive to the configuration data for meeting designated climate sustainability and spectrum efficiency goals for the mobile communications network.

One or more aspects of the subject disclosure include receiving one or more efficiency use case inputs specifying an efficiency target for a mobile communications network, the efficiency use case inputs for meeting designated climate sustainability and spectrum efficiency goals in the mobile communications network, monitoring key performance indicator data (KPIs) of the mobile communications network, the KPIs including one or more of energy consumption KPIs, spectrum usage KPIs, and transport bandwidth utilization KPIs associated with one or more existing network slices of the mobile communications network, determining whether an existing network slice of the one or more existing network slices satisfies the efficiency target for the mobile communications network, generating reconfiguration data for the existing network slice of the one or more network existing slices, wherein the generating the reconfiguration data is in response to a determination that the existing network slice does not satisfy the efficiency target, the reconfiguration data including modification instructions necessary to modify the existing network slice to comply with the efficiency target and modifying the existing network slice responsive to the modification instructions.

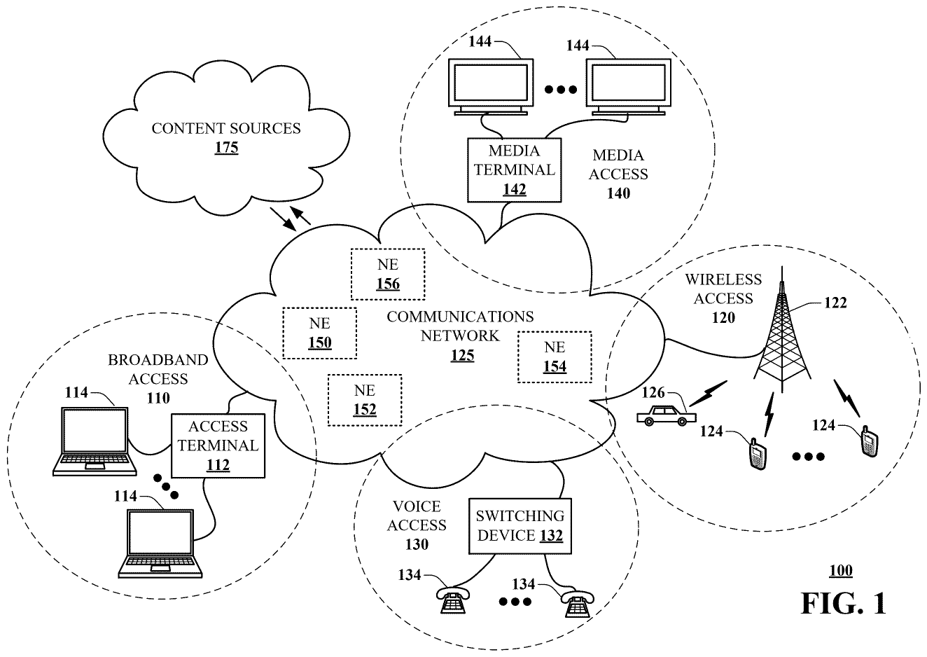

Referring now to FIG. 1, a block diagram is shown illustrating an example, non-limiting embodiment of a system 100 in accordance with various aspects described herein. For example, system 100 can facilitate in whole or in part analyzing efficiency use case inputs, monitoring key performance indicators, and determining whether existing network slices meet designated targets. If the targets are not met, a network blueprint creator generates configuration data for new or modified slices, which are then instantiated and optimized by a slice orchestrator to maintain the efficiency goals. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

A technical problem exists in operating networks such as the communications network 125 given modern constraints on technology. Telecommunications organizations have encountered significant challenges in recent years due to the dual pressures of climate change and the increasing scarcity of radio spectrum resources. Climate commitments to carbon neutrality are driving the pursuit of innovative methods to reduce energy consumption and emissions, while the escalating demand for data transport has resulted in a so-called spectrum desert characterized by limited and costly available radio frequencies. Modifying and improving network structure and operation to better operate under constraints of climate and spectrum is requiring new solutions for improved efficiency in the network.

Existing strategies have endeavored to address these issues through enhancements in network efficiency and resource allocation. As such challenges persist, traditional network infrastructures often struggle to balance energy efficiency with optimal spectrum allocation and bandwidth allocation, thereby necessitating a more integrated and dynamic solution that can adapt to evolving conditions while achieving both environmental and operational objectives.

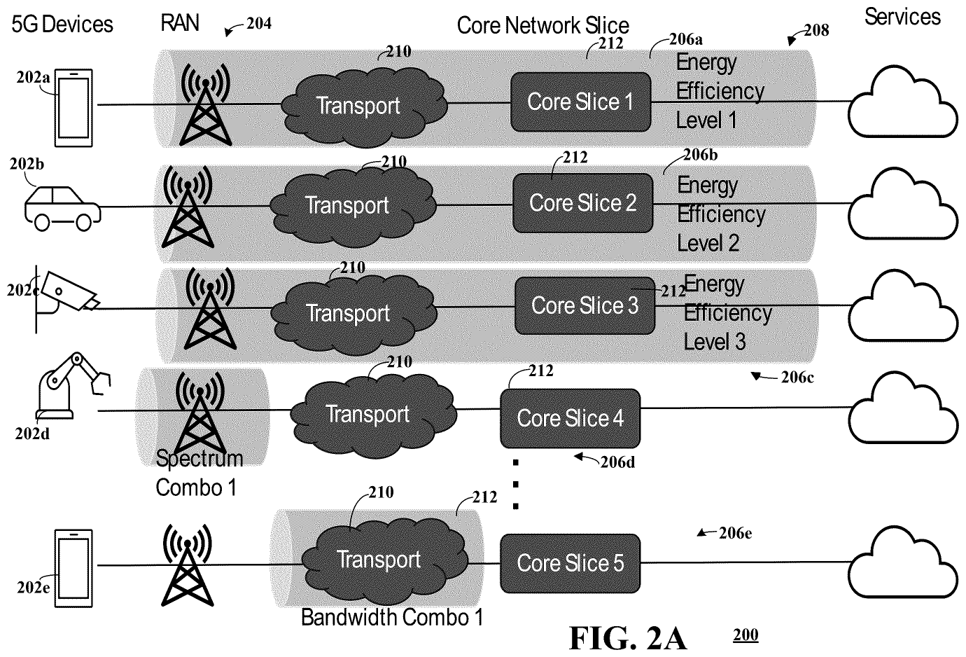

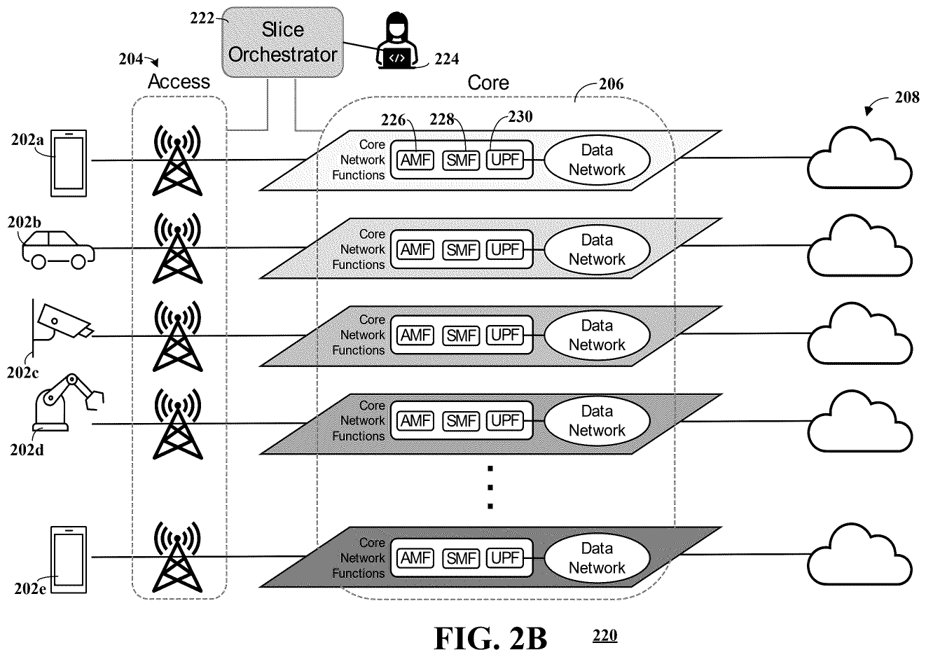

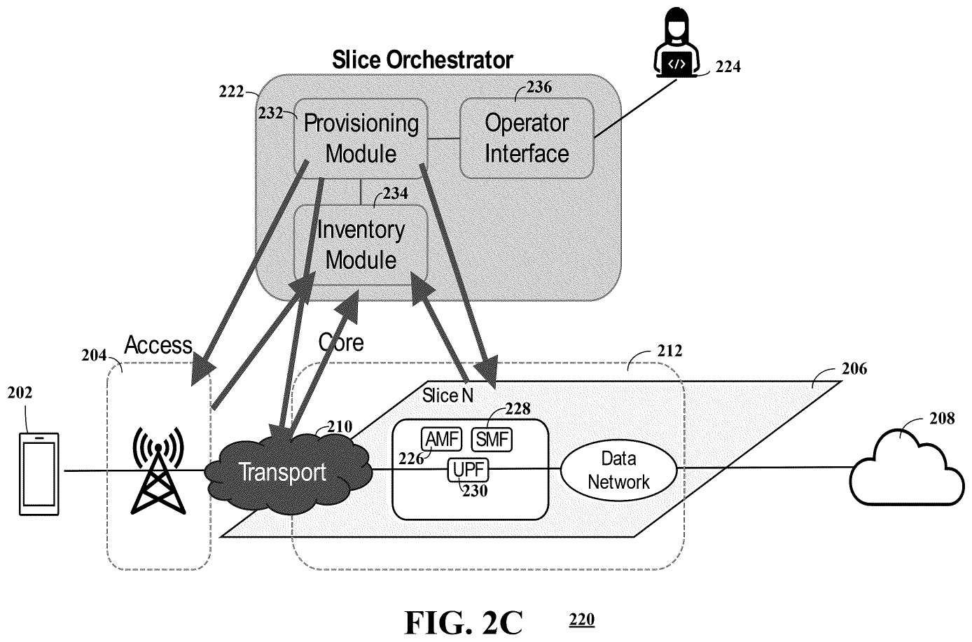

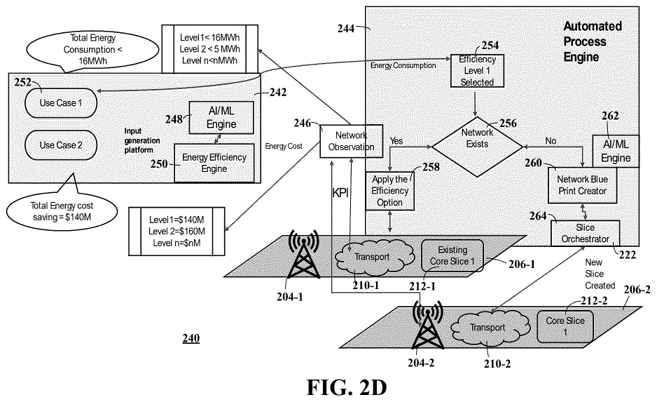

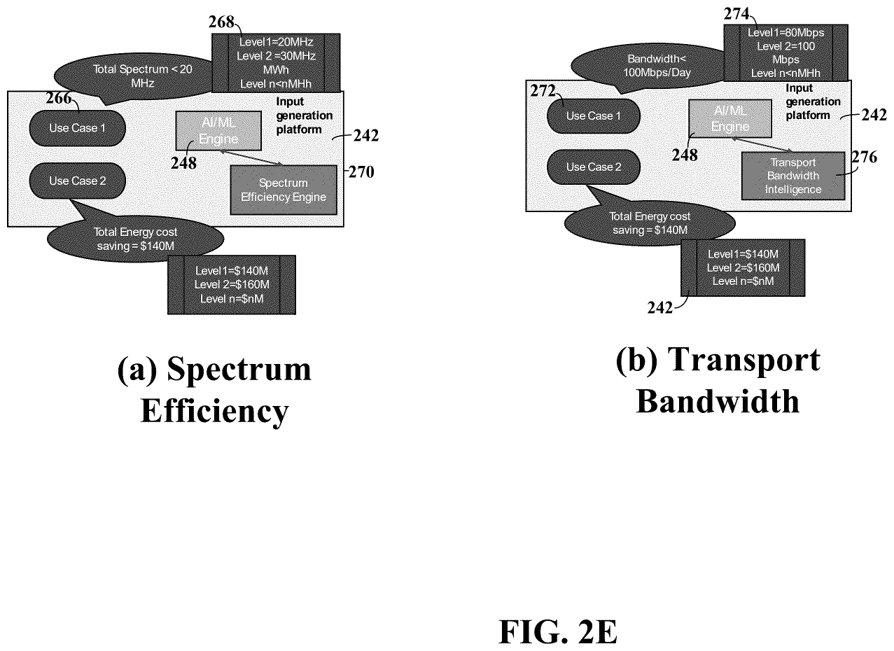

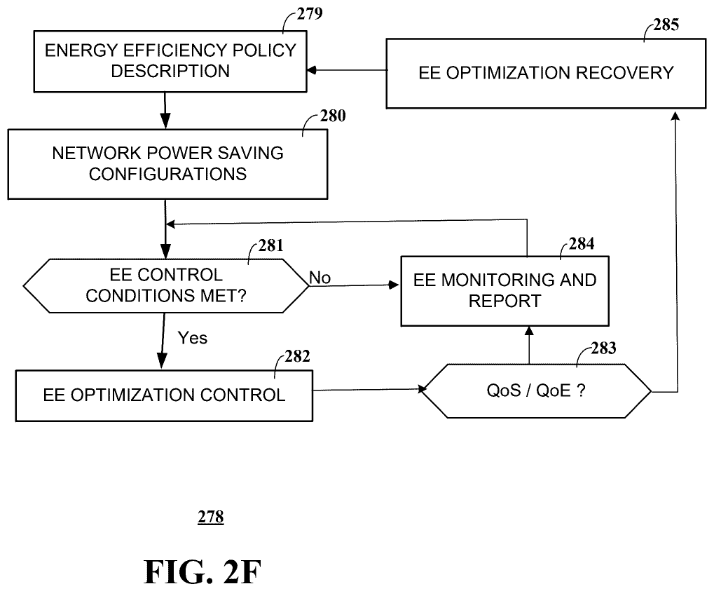

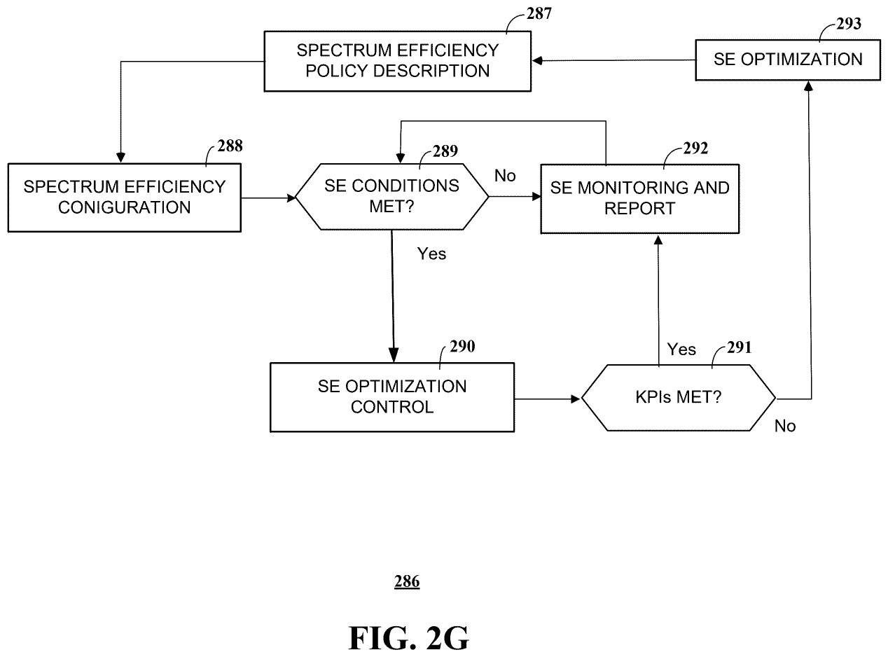

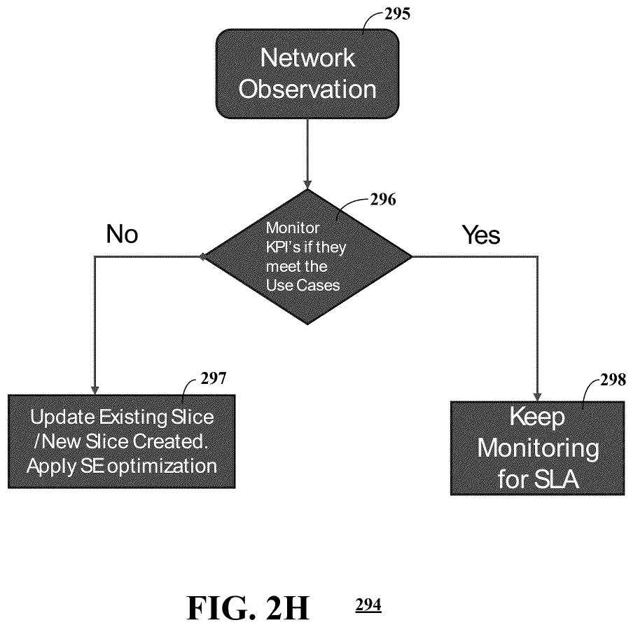

FIG. 2A is a block diagram illustrating an example, non-limiting embodiment of a mobile communication system 200 functioning within the communications network 125 of FIG. 1 in accordance with various aspects described herein. FIG. 2A illustrates a mobile communication system 200 which provides radio communication to a variety of user equipment including a mobile phone 202a, a vehicle 202b, an internet of things (IoT) device 202c, an industrial device 202d and a second mobile phone 202e. Each mobile device communicates with a radio access network (RAN) 204 using an air interface standard such as the fifth generation (5G) standard or sixth generation (6G) standard published by the 3G Partnership Project (3GPP).

The mobile communication system 200 is organized as a plurality of network slices or slices including slice 206a, slice 206b, slice 206c, slice 206d, and slice 206e. In the example, each slice includes a transport network 210 and a core network 212. The core network provides central control and management functions including for example authentication, authorization, mobility management, call and data routing, service processing and billing. The core network 212 includes or communicates with a data gateway which provides access to external networks such as cloud networks 208 and the public internet. The transport network 210 provides data communication and connection between the transport network 210 and the core network 212.

As indicated in FIG. 2A, slice 206a is characterized by a first energy efficiency level. Slice 206b is characterized by a second energy efficiency level. Slice 206c is characterized by a third energy efficiency level. These first three slices are directed to the problem of reducing energy usage and emissions related to issues of climate change.

In slice 206d, the RAN 204 employs a combination of spectrum portions for radio communication with user equipment such as the industrial device 202d. In slice 206e, the transport network 210 uses a combination of bandwidths for communication of data on the transport network 210 between the RAN 204 and the core 212. For example, the mobile network operator may have a corporate goal of using only a specified amount of spectrum in its business. This may be motivated by costs. The more spectrum that is used, the more power that is required for the equipment involved. Moreover, spectrum licenses are relatively expensive and conservation of spectrum usage can help limit the cost of acquiring the spectrum for the RAN 204. A similar analysis applies to the transport network 210. Conventionally, the mobile network operator leases transport facilities such as optical fiber networks for connecting network elements of the mobile network operator such as base stations of the RAN 204 and the servers and switches of the core 212. The cost of such leases is essentially a fixed cost in which the operator leases, for example, 10 gBps of bandwidth for network communications. However, that amount of bandwidth may be required only a peak periods such as a busy hour of the day on the network such as 4:00 to 6:00 PM daily. Other times, such as overnight, the operator requires less bandwidth such as 1 gBps. These second two slices are directed to the problem of conservation of radio spectrum and communication bandwidth in the communications network.

Many enterprises have recognized issues around climate change and endeavored to implement new business practices. This includes operators of mobile networks such as mobile communication system 200. Some new business practices include reducing emissions and reducing enterprise-wide power consumption. Some companies have put in place goals for different measures of energy efficiency. For example, one mobile network operator has a goal of reducing total energy consumption from 18 million MWh to 16 million MWh over 5 years. Another goal provides for increasing use of renewable energy from 0 percent to 17 percent over the same 5 year period. The same company has committed to going carbon neutral by 2035.

At the same time, such mobile network operators have realized that radio spectrum is a sparse resource and is increasingly expensive to acquire. In general, use of radio spectrum in the United States is licensed by the United States government. Different mobile network operators pay licensing fees to acquire exclusive rights to spectrum portions. Because of the competition for limited spectrum, network operators have pressed to use their available spectrum more efficiently.

In some aspects, then, a system and method in accordance with various aspects described herein uses proposed power-saving mechanisms in combination with optimal spectrum usage to meet specific climate sustainability and spectrum usage goals. In an example, dynamic, artificial intelligence/machine learning (AI/ML) deployment is used to meet specific climate sustainability and spectrum usage goals.

Further, the system and method may create marketplace opportunities for a mobile network operator. For example, some customers strongly support goals of energy efficiency, reduced emissions and spectrum conservation. Such customers, both individuals and enterprise customers, may choose to select the service that promises consistency with those noted goals. Some customers may be willing to pay a premium for communications services that further those goals. Even further, a particular network portion such as a slice may be certifiable as carbon neutral or yield carbon credits against tax liability, for example. The carbon credits may be transferable from the mobile network operator to another entity, creating further revenue possibilities for the mobile network operator.

FIG. 2A is therefore a network deployment model that exemplifies five different types of network slices that can be supported with aspects of the system and method described herein. Slice 206a corresponds to a slice that allows the mobile network operator to meet a designated energy efficiency level 1, for example. Slice 206d corresponds to a spectrum combination or combo model. Slice 206e corresponds to a bandwidth combination model. Each of the illustrated slice examples corresponds to a different type of network deployment.

FIG. 2B is a block diagram illustrating an example, non-limiting embodiment of a system 220 for slice orchestration within the mobile communication system of FIG. 2A in accordance with various aspects described herein. The system 220 is similar to the mobile communication system 200 illustrated in FIG. 2A and further includes a slice orchestrator 222 and user interface 224.

In the embodiment of FIG. 2B, each respective slice corresponds to a possible network deployment. Further, each respective slice includes in the core network 212 examples of functional blocks of the core. In the illustrated example, the exemplary functional blocks include an access and mobility function (AMF) 226, a session management function (SMF) 228, and a user plane function (UPF) 230. The AMF 226 handles access control, mobility management and registration of user equipment (UE). The SMF 228 manages user sessions including establishing, modifying and releasing protocol data unit (PDU) sessions. EU PF230 handles actual user data traffic through the network slice. Other functional blocks may be included in the core 212 and in the slice as well.

The slice orchestrator 222 manages and automates network slicing. Network slicing is a network architecture that allows mobile network operators to create multiple virtualized and independent logical networks or slices on a single physical infrastructure. Each slice can be tailored to meet the specific requirements of different applications or services. These include enhanced mobile broadband (eMBB), massive machine type communications mMTC), or ultra reliable low latency communications (URLLC).

The slice orchestrator 222 is responsible for automation and management of the lifecycle of network slices. This may include deploying and configuring the necessary network resources for each slice, monitoring and adjusting slice performance to ensure the slice meets the required service level agreements (SLAs), and dynamically scaling or modifying slices based on changing demands. Further, the slice orchestrator 222 may be responsible for deletion and decommissioning of slices when they are no longer needed. The slice orchestrator 222 automates the complex process of allocating and managing network resources to each to ensure that each slice delivers the required performance.

The user interface 224 provides management and control of the slice orchestrator 222 and the network slicing process for personnel of the mobile network operator. The user interface 224 may accept user commands to configure or monitor the network slices. The user interface 224 may provide operational data and feedback to the operations personnel.

FIG. 2C is a block diagram illustrating example operation of the system 220 for slice orchestration within the mobile communication system of FIG. 2A in accordance with various aspects described herein. FIG. 2C illustrates a single exemplary slice 206 includes a core 212 in data communication with a transport network 210 and an access network such as a RAN 204. A UE 202 is attached to the RAN 204 to access communication services provided by and through the core 212. For example, the core 212, including the UPF 230, may communicate user data between the UE 202 and a remote network such as cloud network 208.

The slice orchestrator 222 in this example includes a provisioning module 232, an inventory module 234, and an operator interface 236. In exemplary operation, the provisioning module 232 communicates with the network including the radio access network 204 and the core 212 to configure the slice 206, based on the network information from the inventory module 234. The inventory module 234 operates to learn and to track the current configuration of the slice 206 and to monitor the operational state of the access network, including RAN 204, and the transport network 210. The inventory module 234 further collects information about and monitors functions of the core network 212, including the AMF 226, the SMF 228 and the UPF 230.

The operator interface 236 enables an operator at the user interface 224 to enter slice characteristics in order to provision the slice 206. The slice 206 may either be a new slice or an existing slice requiring modification to one or more operating features. Parameters for the new instantiation of slice 206 or the modifications to the existing slice may be specified through the user interface 224 interacting with the operator interface 236. In embodiments, any controllable parameters of the slice 206 including the core 212, the transport network 210 and the access network may be established and controlled by the slice orchestrator 222.

The slice orchestrator 222 operates to perform network observation as well. For example, measurements of energy efficiency and spectrum usage are received at the slice orchestrator 222 from, for example, the radio access network RAN 204, the transport network 210 and the core 212. Further, information about data logs with data about operation of the various portions of the slice 206, alarms about current conditions that need attention in the network slice 206 are received at the slice orchestrator 222. Still further, the slice orchestrator 222 monitors key performance indicators (KPIs) and key quality indicators (KCIs). In embodiments, any information generated by the slice 206 including the core 212 and the transport network 210 and the access network may be provided to the slice orchestrator 222.

FIG. 2D is a block diagram illustrating an example, non-limiting embodiment of a system 240 for improving energy efficiency within the mobile communication system 200 of FIG. 2A in accordance with various aspects described herein. The system 240 in the exemplary embodiment includes an input generation platform 242, an automated process engine 244 and a network observation function 246. Other embodiments may include additional or different functions than those illustrated in FIG. 2D. The functional components of the system 240 may be implemented using any suitable data processing device located at any suitable location in the communications network 125 (FIG. 1) or accessible by the communications network 125.

The input generation platform 242 includes an artificial intelligence/machine learning (AI/ML) engine 248 and an energy efficiency engine 250. The input generation platform 242 receives information about a use case or a desired operating configuration for the mobile communications system 200. In particular, the input generation platform 242 receives use case data or information about a use case for a slice 206 of the mobile communications system 200. For example, the use case input data may define an energy efficiency for the slice 206. In a second example, the use case input data may define a spectrum efficiency for a portion of the slice 206 such as the access network or RAN 204 of the slice 206. In a third example, the use case input information may define a transport bandwidth for a portion of the slice such as the transport network 210 for the slice 206. Other use cases are readily apparent and may be defined by particular use case input data. Moreover, a single use case may combine aspects of energy efficiency, spectrum efficiency and bandwidth efficiency for the slice 206.

FIG. 2D illustrates the example where the input generation platform 242 receives input data defining a use case specifying an energy efficiency for a slice of the mobile communications system 200 (FIG. 2A). Any suitable energy efficiency parameter may be specified including, for example, a total energy consumption, total electricity usage, energy intensity, percent total grid electricity, and percent of renewable energy. Other example levels of energy usage or efficiency that may be specified include total on-site renewable energy capacity, renewable energy certificates purchased and power purchased, and total energy used in data centers. The input values may be specified in, for example, MWh or gigajoules.

In accordance with some embodiments, a user such as operations personnel of the mobile network operator may specify a particular level of energy efficiency. In the example, three selectable levels of energy usage are available including level 1, less than 16 MWh, level 2, less than 5 MWh and a user specified level n, less than n MWh where n is a user selectable amount. In FIG. 2D, the selected total energy consumption value of less than 16 MWh is specified as an input 252 to the input generation platform 242.

Also, in accordance with some embodiments, a second use case may be specified by the user. In the example, the second use case is selected from values of total energy cost saving. Levels are available for selection, including level 1, $140 million, level 2, $160 million, and level n, $n million, where n is a user selectable, variable amount.

The network observation function 246 operates to collect data about network operation. Such data may include key performance indicator (KPI) data from existing slices in the communication network. Such collected data may be provided to the input generation platform 242 and used to determine possible, available levels of energy efficiency or spectrum efficiency or bandwidth efficiency. This may limit the user from selecting as a use case a level which is physically unattainable.

The energy efficiency engine 250 of the input generation platform 242 receives the input use case data specifying energy efficiency levels of interest to the user. The energy efficiency engine 250 cooperates with the automated process engine 244 to identify or develop a network slice that can satisfy the requested energy efficiency levels. This may include determining network settings and device settings that will achieve the requested energy efficiency levels. For example, the energy efficiency engine may determine what network elements should be present, how those elements should be configured, and times when the elements should be available. For example, the energy efficiency engine may determine that a predetermined branch of the radio access network should be powered down from midnight to 5:00 AM each day to meet the specified energy goals while still providing required communication service.

The automated process engine 244 receives as an input 254 a selected efficiency level specified or selected by a user or other process. At step 256, the automated process engine 244 determines if a network or network slice currently exists in the network that may satisfy the selected efficiency level received at input 254. For example, the mobile communications network may already have a slice that is meeting the specified goal. If so, at step 258, the efficiency option specified by the input 254 is applied to the existing slice. In the example, existing slice 206-1 satisfies the requirements and is thus designated and selected. The automated process engine 244 may use input information such as KPIs and other data from the network observation function 246 to inform the decision of step 256. Subsequent to selection and designation of the existing slice 206-1 as the slice satisfying the input conditions, the network observation function 246 and the automated process engine 244 may continue to monitor the performance of the existing slice 206-1 to ensure that the existing slice 206-1 continues to satisfy the performance goal.

In this example, the existing slice 206-1 includes an existing access network 204-1, an existing transport network 210-1 and an existing core 212-1. These components may be configured to process communications traffic under control of automatic processes or under control of a user.

At step 256, if no existing slice satisfies the energy efficiency goals specified at the input 254, a network blueprint creator 260 is activated to develop the required slice. The network blueprint creator 260 may be implemented as a module including hardware, software or a combination of these. Further, the network blueprint creator 260 may cooperate with an AI/ML engine 262 to identify, select and customize the components required to instantiate a new slice 206-2. In embodiments, the network blueprint creator may operate to generate modification instructions necessary to modify the existing network slice to comply with predetermined efficiency goals specified by the use case input data. For example, the network blueprint creator 260 may generate configuration instructions including a definition of network elements for the new network slice and required numbers of the network elements for the new network slice. Such configuration instructions may include a number of AMF modules such as AMF 226, a number of SMF modules such as SMF 228 and a number of UPF modules such as UPF 230 (FIG. 2C) for a core network of the new network slice. Configuration instructions generated by the network blueprint creator 260 may further include network element settings and operational schedules for the network elements for the new network slice. For example, to manage energy efficiency, spectrum usage efficiency and bandwidth usage efficiency, the network blueprint creator 260 may determine, and specify in configuration instructions, that a particular core network of the new network slice may only operate from Midnight to 5:00 AM in order to achieve the efficiency goals.

Instantiating a new network slice in a cellular network refers to the process of creating and activating a dedicated, logical network partition tailored to specific service requirements. Each slice is designed to meet the unique needs of a particular service or application. Instantiation of a network slice means bringing a specific slice into existence and making it operational. This involves allocating and configuring the necessary network resources, including, for example, radio access network (RAN) resources such as bandwidth and spectrum, transport network resources such as latency and bandwidth, and core network functions such as mobility management, session management. In particular examples, slice instantiation may involve steps of resource allocation, or dynamically allocating network resources based on the slice's requirements, device configuration, or defining and establishing network functions and parameters to match the slice's specific needs, and orchestration and automation. Network slices can be created and modified dynamically, allowing operators to adapt to changing service demands.

In general, when instantiating the new slice, physical elements are available, such as a radio access network 204-2 and a transport network 210-2, and may be communicably combined with core functions of a core 212-2 such as an AMF, a SMF and a UPF to form the core 206-2. The network blueprint creator 260 further cooperates with the slice orchestrator 264 to instantiate and activate the new slice 2006-2 and place the new slice into service. The automated process engine 244 may further cooperate with the network observation function 246 to monitor performance of the new slice 206-2 to ensure that the selected efficiency level is maintained.

FIG. 2E is a block diagram illustrating additional example, non-limiting embodiments of a system for improving spectrum efficiency within the mobile communication system of FIG. 2A in accordance with various aspects described herein. FIG. 2E(a) illustrates an example of use of the illustrated system and method for specifying a desired spectrum efficiency. FIG. 2E(b) illustrates an example of use of the illustrated system and method for specifying a transport bandwidth.

In the example of FIG. 2E(a), the selected input parameter relates to spectrum usage in a portion of the network such as a network slice. In this example, rather than specifying the total energy consumption as the use case 252, a value for total spectrum usage may be specified for the use case 266. Again, the input 268 may have user selectable or specifiable values such as level 1 equal to 20 MHz maximum spectrum usage, level 2 equal to 20 MHz total spectrum usage, and a level n specifying a user selectable value for maximum spectrum usage.

In this example of FIG. 2E(a), rather than an energy efficiency engine 250, the input generation platform 242 implements a spectrum efficiency engine 270. Based on operational data received from the network observation function 246, the spectrum efficiency engine 270 identifies network and device settings necessary to achieve the specified spectrum efficiency goal for the use case 266 corresponding to the input 268. For example, the spectrum efficiency engine may identify one or base stations or gNodeB devices in the mobile communications network having adequate technical abilities to meet the input requirements. The input generation platform 242 then may cooperate with the automated process engine 244 to locate an existing slice 206-1 or instantiate a new slice 206-2 to fulfill the input requirements.

Similarly, in the example of FIG. 2E(b), the selected input parameter relates to spectrum transport bandwidth utilized in a portion of the network such as a transport network of a network slice. In this example, rather than specifying the total energy consumption as the use case 252 (FIG. 2D), a value for total transport bandwidth usage may be specified for the use case 272. Again, the input 274 may have user selectable or specifiable values such as level 1 equal to 80 Mbps, level 2 equal to 100 Mbps, and a level n specifying a user selectable value for maximum transport bandwidth.

In the example of FIG. 2E(b), rather than an energy efficiency engine 250, the input generation platform 242 implements a transport bandwidth engine 276. Based on operational data received from the network observation function 246, the transport bandwidth engine 276 identifies network and device settings necessary to achieve the specified spectrum efficiency goal for the use case 272 corresponding to the input 274. For example, the spectrum efficiency engine may identify an optical network that is available to connect base stations in the mobile communications network to the core network to meet the input requirements of input 274. The input generation platform 242 then may cooperate with the automated process engine 244 to locate an existing slice 206-1 or instantiate a new slice 206-2 (FIG. 2D) to fulfill the input requirements.

FIG. 2F depicts an illustrative embodiment of a method 278 in accordance with various aspects described herein. FIG. 2F illustrates a flowchart for an energy efficiency optimization process within the context of the network systems depicted in FIGS. 2D and 2E. The exemplary flowchart of FIG. 2F outlines the steps involved in monitoring and optimizing energy efficiency across network slices.

The method 278 begins at step 279 with the energy efficiency policy description, where policies are defined to guide the network's power-saving configurations. These policies are important for setting the parameters and conditions under which energy efficiency measures are implemented. Such policies may relate to identifying equipment and network functions, power saving modes, energy efficiency control valid time and power saving status exchange chain descriptions. Further, such policies may relate to equipment and network deployment scenarios power saving conditions including traffic profiles network load time and location.

Based on these policies established at step 279, at step 280, the network configures its power-saving measures, informed by the AI/ML engine and energy efficiency engine depicted in FIG. 2D. In embodiments, the energy efficiency engine 250 may determine optimal settings for energy consumption.

At step 281, the method 278 then determines whether the energy efficiency control conditions are met. This may involve monitoring key performance indicators (KPIs) and other metrics. In embodiments, this may employ the network observation function 246 of FIG. 2D.

If the conditions are not met at step 281, the method 278 moves to monitoring and reporting. The system continues to observe energy efficiency and generate reports. In particular, the method may include receiving from the network observation function 246 information about energy efficiency (EE) KPIs and assessing the significance of the EE KPIs. For example, respective KPI values may be compared with a preexisting threshold to determine information about energy efficient operation in the slice of interest. In another example, trend data for KPIs measured over time may be determined to measure temporal variation of the energy efficiency of the slice.

Such ongoing observation is important for identifying areas where further optimization is needed. If the control conditions are met, the system proceeds with energy efficiency optimization, adjusting network operations to maintain or improve energy efficiency, leveraging the automated process engine 244 from FIG. 2D to apply the necessary changes.

At step 283, the method 278 further evaluates whether the quality of service (QoS) or quality of experience (QoE) are satisfactory. QoS refers to the ability of the mobile communications network to provide a designated level of assurance that traffic will be delivered with predictable characteristics. Different types of calls or data flows have different requirements. For example, voice and video data gets a higher priority over data downloads. QoE relates to an overall experience of service quality of a user. Evaluation of QoS and QoE helps to ensure that energy efficiency measures do not compromise the user experience.

If optimization is required, at step 285 the method 278 initiates recovery actions to bring the network back to optimal energy efficiency levels, which may involve creating new network slices or adjusting existing ones, as described in FIG. 2D's network blueprint creator and slice orchestrator. Energy efficiency optimization may include disabling a power saving mode of components of a slice, and adjusting an energy efficiency policy adjustment.

FIG. 2G depicts an illustrative embodiment of a method 286 in accordance with various aspects described herein. FIG. 2G illustrates an exemplary flowchart for spectrum efficiency optimization and bandwidth efficiency optimization within the context of the network systems depicted in FIGS. 2D and 2E. This flowchart outlines the steps involved in monitoring and optimizing spectrum efficiency across network slices.

The method 286 begins with step 287, which involves spectrum efficiency policy description. This step defines the policies that guide the network's spectrum-saving configurations. These policies are important for setting the parameters and conditions under which spectrum efficiency measures are implemented. The policies are informed by the AI/ML engine and spectrum efficiency engine depicted in FIG. 2E, which determine the optimal settings for spectrum utilization.

In exemplary embodiments, spectrum policy description of step 287 should define the several attributes. These include an Equipment/Network Functions identifier, or the equipment/network functions where the policy should be applied; bandwidth saving modes including reduced bandwidth throttle mode, other advanced bandwidth saving modes; efficient spectrum(ES) control enabling time. or the time when ES control policies should be applied (in combination with other attributes). The attributes further include bandwidth saving status; required KPI's, or the mobile network operator's defined values as a target spectrum efficiency KPI. Attributes may further include bandwidth saving options, related to the enabling or disabling of pre-defined bandwidth saving operations. These may include, for example, Throttle Bandwidth to a certain threshold and Reduce the number of servers or connections.

In step 288, the network configures its spectrum efficiency measures based on the policies described in step 287. This configuration is important for ensuring that the network or slice operates within the defined spectrum efficiency parameters. The spectrum efficiency engine 270 and transport bandwidth engine 276 of FIG. 2E play a role in identifying the necessary network and device settings to achieve the specified spectrum efficiency goals.

Step 289 involves checking whether the spectrum efficiency control conditions are met. This step may involve monitoring key performance indicators (KPIs) and other metrics, similar to the network observation function 246 of FIG. 2D. If the conditions are not met, the method 286 moves to step 292, where the system continues to monitor spectrum efficiency and generate reports. This ongoing observation is useful for identifying areas where further optimization is needed.

If the control conditions are met at step 289, the method 286 proceeds to step 290, which involves spectrum efficiency optimization control. Step 289 may include enabling bandwidth saving mode and monitoring bandwidth saving status. This step adjusts network operations to maintain or improve spectrum efficiency, leveraging the automated process engine from FIG. 2D to apply the necessary changes. The goal is to ensure that the network meets the required spectrum efficiency levels without compromising service quality.

At step 291, the method 286 includes evaluating whether the KPIs are met, ensuring that the spectrum efficiency measures are effective. If the KPIs are not met, the system continues to monitor and report on spectrum efficiency in step 292. This step is important for maintaining a feedback loop that informs ongoing optimization efforts.

Finally, step 293 involves spectrum efficiency optimization, where the system makes necessary adjustments to optimize spectrum usage. This step may involve creating new network slices or adjusting existing ones, as described in connection with FIG. 2D's network blueprint creator 260 and slice orchestrator 222. Method 286 thus enables integration of these processes to achieve spectrum efficiency within network operations, linking back to the overall goal of maintaining efficient network operations while meeting specific spectrum usage targets.

FIG. 2H depicts an illustrative embodiment of a method 294 in accordance with various aspects described herein. FIG. 2H illustrates an exemplary flowchart for network observation and optimization within the context of the network systems depicted in FIGS. 2D and 2E. This flowchart outlines the method steps involved in monitoring key performance indicators (KPIs) and applying optimization strategies across network slices.

The method 294 begins with step 295, which involves network observation. This step involves continuously monitoring the network's performance, including energy efficiency, spectrum usage in radio access networks and bandwidth usage in transport networks. The network observation function 246, as depicted in FIG. 2D, collects data on KPIs and other metrics, providing a comprehensive view of the network's operational state. This ongoing observation enables identifying areas where optimization is needed.

In step 296, the system monitors KPIs to determine if they meet the use cases defined for the network slices. This step may involve assessing whether the network's performance aligns with the predefined goals for energy efficiency, FIG. 2D, and spectrum utilization and bandwidth efficiency, FIG. 2E. If the KPIs are met, the process moves to step 298, where the system continues to monitor for conformity with service level agreements (SLAs), ensuring that the network maintains its performance standards. In the context of a mobile communications network, a SLA is a contract between a mobile network operator and its customers, particularly business customers, that outlines the expected level of service. An SLA establishes clear expectations for both the provider and the customer regarding the quality and reliability of the cellular services. The SLA defines consequences if the operator fails to meet those standards, often including service credits or other forms of compensation.

If the KPIs are not met, the process proceeds to step 297, which involves updating existing slices or creating new slices to apply spectrum efficiency optimization. This step may involve leveraging the network blueprint creator 260 and slice orchestrator 264 from FIG. 2D to adjust the network configuration and improve performance. The automated process engine 244 plays a significant role in implementing these changes, ensuring that the network adapts to meet the required efficiency levels.

Step 298 involves continuing to monitor for SLA compliance, ensuring that the network continues to meet the agreed-upon performance standards. This step maintains a feedback loop that informs ongoing optimization efforts, linking back to the overall goal of maintaining efficient network operations while meeting specific energy and spectrum usage targets. These processes operate to achieve climate sustainability, spectrum efficiency and bandwidth within network operations, leveraging the capabilities of AI/ML engines and optimization strategies depicted in FIGS. 2D and 2E.

While for purposes of simplicity of explanation, the respective processes are shown and described as a series of blocks in FIG. 2F, FIG. 2G, and FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

From the foregoing, it can be seen that the present disclosure enables the integration of AI-driven mechanisms to achieve climate sustainability and spectrum efficiency within network operations. This system and method introduce an automated process that leverages network slicing, orchestrated by a slice orchestrator, to dynamically deploy network slices tailored to meet specific energy efficiency and spectrum utilization goals. Embodiments of the system incorporates an AI/ML engine to suggest efficiency levels based on predefined energy and bandwidth consumption targets, and a generative AI engine to create new network slices that optimize these parameters. The development further includes a network blueprint creator, which utilizes AI/ML rules to satisfy energy and bandwidth consumption goals, and an automated process engine to verify existing network capabilities against requested efficiency levels. Additionally, the system proposes novel efficiency control processes for spectrum bandwidth and transport bandwidth, defining attributes and lifecycle management for bandwidth optimization. This comprehensive approach not only addresses the challenges of climate change and spectrum scarcity but also offers potential revenue opportunities through energy-efficient services.

In an alternate embodiment, the system incorporates a predictive analytics module that leverages historical data and machine learning algorithms to forecast network demand and preemptively adjust network slices. This module works in conjunction with the AI/ML engine to anticipate periods of high energy consumption or spectrum usage, allowing the network to proactively reconfigure slices to maintain efficiency targets. Additionally, the system may integrate a user feedback mechanism that allows end-users to input preferences for energy efficiency or service quality, which the input generation platform could use to tailor network configurations more closely to user needs.

Another embodiment involves the use of decentralized edge computing resources to enhance the system's responsiveness and reduce latency in network slice adjustments. By deploying edge nodes closer to end-users, the system performs real-time data processing and decision-making, thereby improving the speed and accuracy of network slice reconfigurations. This approach is particularly beneficial in scenarios where rapid changes in network conditions occur, such as during large public events or in disaster recovery situations.

A further embodiment explores the integration of renewable energy sources directly into the network infrastructure. The system may include a renewable energy management module that monitors the availability and usage of renewable energy within the network. This module works with the energy efficiency engine to optimize the use of renewable energy, ensuring that network slices are powered by sustainable sources whenever possible, thus enhancing the network's overall sustainability profile.

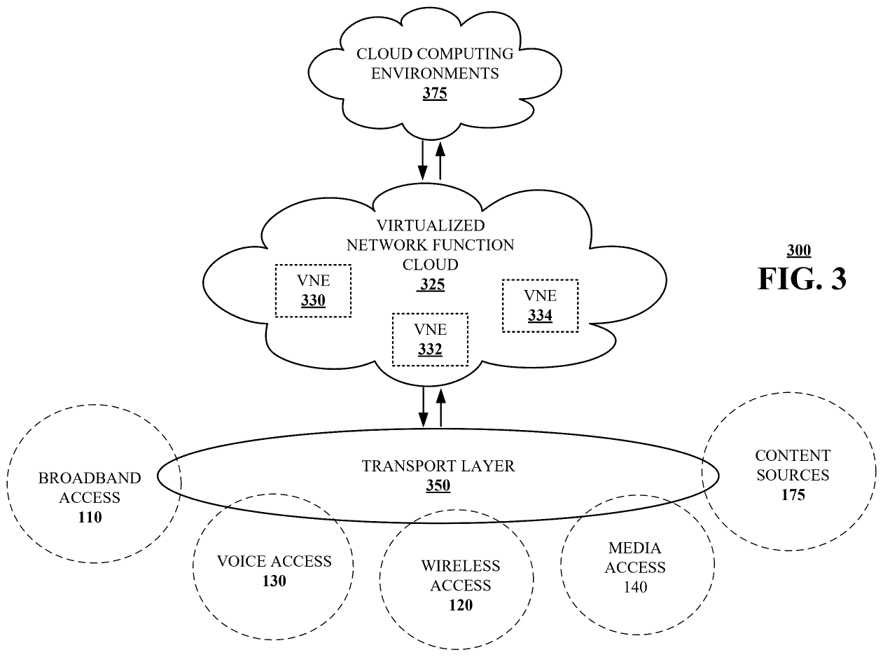

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of the mobile communication system 200, system 220, system 240 and method 278, method 286, and method 294 presented in FIG. 1, FIG. 2A, FIG. 2B, FIG. 2C, FIG. 2D, FIG. 2F, FIG. 2G, FIG. 2H and FIG. 3. For example, virtualized communication network 300 can facilitate in whole or in part analyzing efficiency use case inputs, monitoring key performance indicators, and determining whether existing network slices meet designated targets. If the targets are not met, a network blueprint creator generates configuration data for new or modified slices, which are then instantiated and optimized by a slice orchestrator to maintain the efficiency goals.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

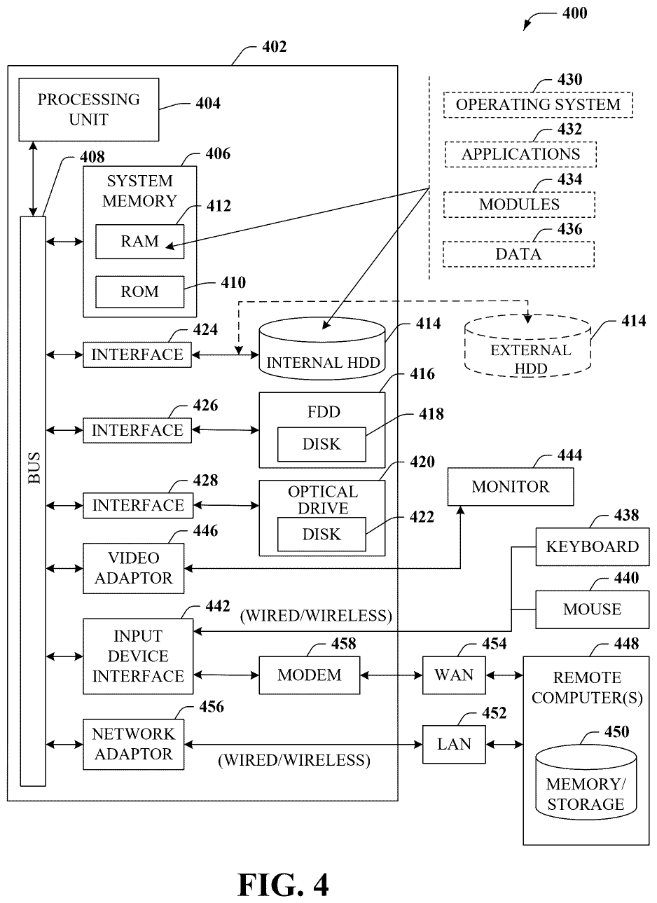

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part analyzing efficiency use case inputs, monitoring key performance indicators, and determining whether existing network slices meet designated targets. If the targets are not met, a network blueprint creator generates configuration data for new or modified slices, which are then instantiated and optimized by a slice orchestrator to maintain the efficiency goals.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

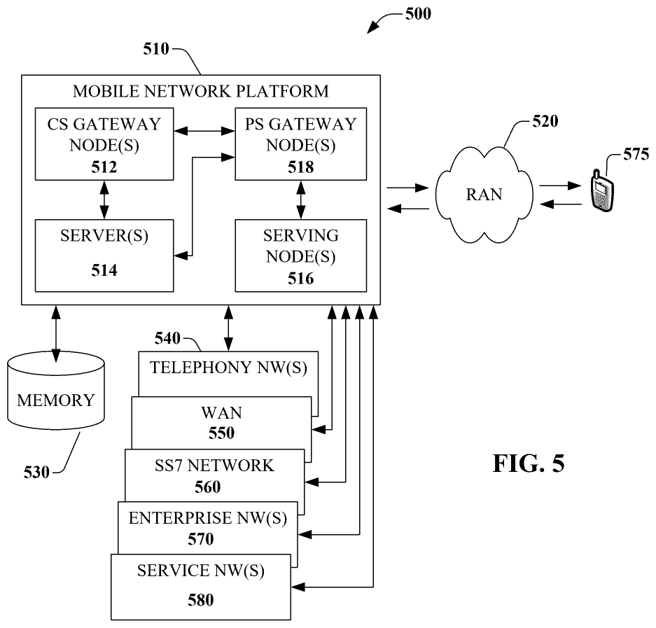

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part analyzing efficiency use case inputs, monitoring key performance indicators, and determining whether existing network slices meet designated targets. If the targets are not met, a network blueprint creator generates configuration data for new or modified slices, which are then instantiated and optimized by a slice orchestrator to maintain the efficiency goals. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

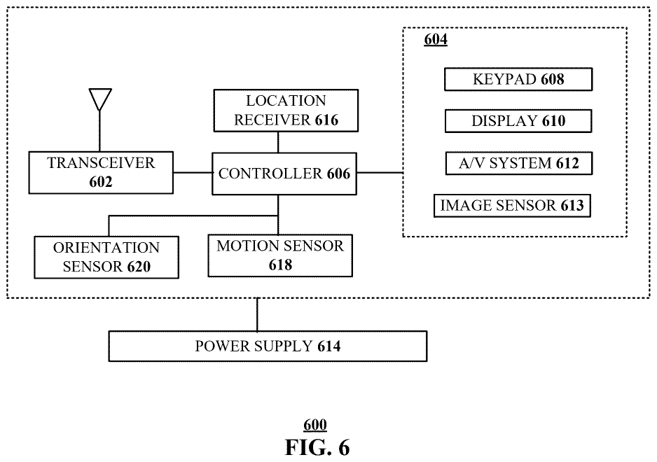

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, coommunication device 600 can facilitate in whole or in part analyzing efficiency use case inputs, monitoring key performance indicators, and determining whether existing network slices meet designated targets. If the targets are not met, a network blueprint creator generates configuration data for new or modified slices, which are then instantiated and optimized by a slice orchestrator to maintain the efficiency goals.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ ... xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
an input generation platform configured to receive use case input data specifying desired efficiency parameters for configuring a mobile communications network to achieve predetermined efficiency goals;
an efficiency engine operatively coupled to the input generation platform and configured for analyzing the use case input data and for determining, based on the analyzing, an efficiency level corresponding to the desired efficiency parameters;
an automated process engine operatively coupled to the efficiency engine, the automated process engine assessing whether an existing network slice of a mobile communications network meets the efficiency level, forming an efficiency assessment, and based on the efficiency assessment, triggering a network creation function; and
a network blueprint creator operatively coupled to the automated process engine for performing the network creation function, the network blueprint creator configured to generate configuration instructions necessary to instantiate a new network slice to comply with the predetermined efficiency goals.

2. The device of claim 1, further comprising:
a slice orchestrator operatively coupled to the network blueprint creator, the slice orchestrator configured to instantiate the new network slice responsive to the configuration instructions.

3. The device of claim 1, wherein the network blueprint creator is configured to generate the configuration instructions including a definition of network elements for the new network slice and required numbers of the network elements for the new network slice.

4. The device of claim 3, wherein the network blueprint creator is configured to generate the configuration instructions including network element settings and operational schedules for the network elements for the new network slice.

5. The device of claim 1, wherein the network blueprint creator is configured to generate modification instructions necessary to modify the existing network slice to comply with the predetermined efficiency goals.

6. The device of claim 5, further comprising:
a slice orchestrator operatively coupled to the network blueprint creator, the slice orchestrator configured to modify the existing network slice responsive to the modification instructions.

7. The device of claim 1, wherein the input generation platform is configured to receive energy consumption, spectrum usage, and transport bandwidth efficiency parameters among the use case input data specifying desired efficiency parameters.

8. The device of claim 7, wherein the automated process engine is configured to apply an efficiency option to the existing network slice to thereby modify the existing network slice to comply with the predetermined efficiency goals.

9. The device of claim 8, wherein the input generation platform is configured to receive a user selected efficiency option among the use case input data.

10. The device of claim 9, wherein the input generation platform is configured to receive one of a target energy consumption level for the mobile communications network, a total spectrum usage level for a radio access network of the mobile communications network, and a target bandwidth usage level for a transport network of the mobile communications network as the user selected efficiency option.

11. A non-transitory machine-readable medium, comprising executable instructions that, when executed by a processing system including a processor, facilitate performance of operations, the operations comprising:
receiving one or more efficiency use case inputs specifying an efficiency target for a mobile communications network;
monitoring one or more key performance indicators (KPIs) including energy consumption, spectrum usage, and transport bandwidth utilization, wherein the one or more KPIs are associated with one or more existing network slices of the mobile communications network;
automatically determining whether an existing network slice of the one or more existing network slices satisfies the efficiency target;
generating configuration data for a new network slice in response to a determination that the existing network slice does not satisfy the efficiency target; and
in a slice orchestrator, creating and provisioning the new network slice responsive to the configuration data for meeting designated climate sustainability and spectrum efficiency goals for the mobile communications network.

12. The non-transitory machine-readable medium of claim 11, wherein the receiving one or more efficiency use case inputs comprises:
receiving efficiency use case inputs specifying one or more of an energy efficiency target, a spectrum utilization target, and a bandwidth usage target for the existing network slice.

13. The non-transitory machine-readable medium of claim 11, wherein the operations further comprise:
instantiating the new network slice, wherein operation of the new network slice is defined by operational parameters based on the configuration data;
monitoring the one or more KPIs to assess real-time network performance of the mobile communications network; and
adjusting the operational parameters of the new network slice to maintain the efficiency target.

14. The non-transitory machine-readable medium of claim 11, wherein the operations further comprise:
generating reconfiguration data for an existing network slice of the one or more existing network slices in response to a determination that the existing network slice does not satisfy the efficiency target, the reconfiguration data including modification instructions necessary to modify the existing network slice to comply with the efficiency target; and
modifying, in a slice orchestrator, the existing network slice responsive to the modification instructions.

15. The non-transitory machine-readable medium of claim 11, wherein the receiving one or more efficiency use case inputs specifying an efficiency target comprises:
receiving one or more of a target energy consumption level for the mobile communications network, a total spectrum usage level for a radio access network of the mobile communications network, and a target bandwidth usage level for a transport network of the mobile communications network.

16. A method, comprising:
receiving, by a processing system including a processor, one or more efficiency use case inputs specifying an efficiency target for a mobile communications network, the efficiency use case inputs for meeting designated climate sustainability and spectrum efficiency goals in the mobile communications network;
monitoring, by the processing system, key performance indicator data (KPIs) of the mobile communications network, wherein the KPIs include one or more of energy consumption KPIs, spectrum usage KPIs, and transport bandwidth utilization KPIs associated with one or more existing network slices of the mobile communications network;
determining, by the processing system, whether an existing network slice of the one or more existing network slices satisfies the efficiency target for the mobile communications network;
generating, by the processing system, reconfiguration data for the existing network slice of the one or more existing network slices, wherein the generating the reconfiguration data is in response to a determination that the existing network slice does not satisfy the efficiency target, the reconfiguration data including modification instructions necessary to modify the existing network slice to comply with the efficiency target; and
modifying, by the processing system, the existing network slice responsive to the modification instructions.

17. The method of claim 16, comprising:
generating, by the processing system, configuration data for a new network slice in response to a determination that the existing network slice does not satisfy the efficiency target; and
orchestrating, by the processing system, creation and provisioning of the new network slice responsive to the configuration data.

18. The method of claim 17, comprising:
instantiating, by the processing system, the new network slice, wherein operation of the new network slice is defined by operational parameters based on the configuration data.

19. The method of claim 18, comprising:
monitoring, by the processing system, the KPIs to assess real-time network performance of the mobile communications network; and
adjusting, by the processing system, the operational parameters of the new network slice to maintain the efficiency target.

20. The method of claim 17, wherein the generating the configuration data for the new network slice comprises:
defining, by the processing system, network elements for the new network slice;
defining, by the processing system, required numbers of the network elements for the new network slice; and
defining, by the processing system, network element settings and operational schedules for the network elements for the new network slice.
